(19) United States
(12) Patent Application Publication
(10) Pub. No.: US 2026/0180167 A1
(43) Pub. Date: Jun. 25, 2026

(54) MIMO ANTENNA WITH DECOUPLING CIRCUITRY

(71) Applicant: Norsat International Inc., Richmond (CA)

(72) Inventors: Dong Wang, Waterloo (CA); Yazi Cao, Newmarket (CA); Yiyao Hu, Aurora (CA); Jan Koivunen, Thornhill (CA); Tong Li, Aurora (CA)

(73) Assignee: Norsat International Inc., Richmond, BC (CA)

(21) Appl. No.: 18/991,137

(22) Filed: Dec. 20, 2024

(51) Int. Cl. H01Q 1/52; H01Q 1/42; H01Q 5/321; H01Q 5/335; H01Q 9/40

(52) U.S. Cl. CPC H01Q 1/521; H01Q 1/42; H01Q 5/321; H01Q 5/335; H01Q 9/40

(57) ABSTRACT

A low-profile, highly isolated, ultra-wideband multiple-input and multiple-output (MIMO) antenna for use in a distributed antenna system includes: (a) a feeding circuit on a dielectric substrate that includes a coplanar waveguide (CPW) including a signal feed and a return that includes first and second return sections coplanar with and apart from the signal feed; (b) first and second radiator circuits including first and second monopole radiators, respectively, the first and second return sections being coplanar with and spaced apart from the first monopole radiator; (c) a decoupling circuit, disposed on a first side of the dielectric substrate, that includes a conductive strip for reducing mutual coupling between the first and second radiator circuits; and (d) a matching circuit including a plurality of stubs disposed on a second side of the dielectric substrate opposite the first side, the matching circuit being operable to reduce return loss of the MIMO antenna.

### BACKGROUND OF THE INVENTION

### 1. Field of Invention

This invention relates to the transmission of electromagnetic radiation in a cellular distributed antenna system (DAS) and, in particular, to a low profile, ultra wideband multiple-input and multiple-output (MIMO) antenna with decoupling circuitry for high isolation between multiple radiator circuits of the MIMO antenna.

### 2. Description of Related Art

A distributed antenna system (DAS) is a network of spatially separated DAS antennas connected to a common signal-feed source via feed cables. The DAS provides wireless service within specified frequency bands, and the DAS antennas are known to be mounted indoors to a ceiling within a building structure such that the feed cables are hidden from view within the plenum space of the building structure.

United States patent No. 2020/0091618 A1 to Kok Jiunn N G et al. discloses an indoor, ceiling-mounted, low profile, ultra-wideband, omnidirectional antenna comprising a monopole. However, the antenna of Kok Jiunn N G et al. is not a MIMO antenna.

U.S. Pat. No.10,680,339 B2 to Kok Jiunn Ng et al., which is titled Low Profile Omnidirectional Ceiling Mount Multiple-Input Multiple-Output (MIMO) Antennas, discloses a planar antenna suitable for being fixed to a ceiling and operable to transmit electromagnetic radiation in a band (from about 600 MHz to about 6000 MHz). However, the planar antenna of Kok Jiunn Ng et al. uses microstrip feeding techniques and is not useable in the 6000 MHz-8500 MHz band.

An object of the invention is to address the above shortcomings, such as by embodiments that use a novel feeding technique and a novel mutual decoupling technique.

### SUMMARY OF THE INVENTION

The above shortcomings may be addressed by providing, in accordance with one aspect of the invention, an antenna for use in a distributed antenna system. The antenna includes: (a) a coplanar waveguide (CPW) feeding circuit disposed on a first side of dielectric, the feeding circuit comprising a coplanar waveguide comprising a signal feed and a signal return coplanar; (b) a radiator circuit disposed on a first and a second side of a dielectric, the radiator circuit comprising a monopole radiator and a radiator return coplanar with and spaced apart from the monopole radiator, the first side radiator capacitively coupling the second side radiator; and (c) a specific microstrip between MIMO antenna increases the isolation to the desired value.

The antenna may include a radiator and an impedance-matching circuit design. The impedance-matching circuit may include a stub on the dielectric. The radiator may define a trace-free gap between the signal feed and the ground. The antenna may include a first single-layer PCB (Printed Circuit Board) and a second single-layer PCB. The first single-layer PCB may include the CPW feeding circuit, antenna ground, antenna radiator and the decoupling circuit. The second single-layer PCB may include the CPW ground, capacitive coupled radiator circuit, and the matching circuit stubs. The antenna may include a two-layer PCB (Printed Circuit Board). The two-layer PCB may include the feeding circuit, radiator circuit, matching circuit and the decoupling circuit. The antenna may include a radome. The radome may be operable to enclose the feeding circuit in a water-resistant enclosure. The radome may be dimensioned for a PCB and a cable holder. The cable holder may be operable to receive a feed cable. The feed cable may include a signal conductor and a ground conductor. The cable holder may be dimensioned to receive the feed cable such that the signal conductor is electrically connectable to the signal feed. The cable holder may be dimensioned to receive the feed cable such that the ground is electrically connectable to the radiator return. The antenna may be dimensioned for receiving a plurality of fasteners for mounting the antenna to a building structure while the plurality of fasteners is electrically isolated from the radiator circuit, the feeding circuit. The plurality of fasteners may include a plurality of spacers for maintaining a separation between the antenna and the building structure. The antenna may be operable to transmit electromagnetic radiation in a plurality of frequency bands within the frequency range of 617 MHz (Mega Hertz) to 8500 MHz. One or more of the feeding circuits, the radiator circuits, and the isolation circuits.

In accordance with another aspect of the invention, there is provided an antenna for use in a distributed antenna system. The antenna includes: (a) a radiator device for wirelessly sending and receiving signals; (b) a CPW feeding device for coupling the signal to the radiator; a decoupling circuit device for increasing the isolation of the MIMO antenna; and (d) a matching circuit device for reducing impedance mismatch.

The antenna may include means for conditioning the signal. The antenna may include means for enclosing the feeding means. The antenna may include means for mounting the radiator means.

In accordance with another aspect of the invention, there is provided a low profile, highly isolated ultra-wideband multiple-input and multiple-output (MIMO) antenna that covers many cellular bands for distributed antenna system (DAS) applications. The antenna includes: (a) a coplanar waveguide (CPW) circuit design on a first side of a dielectric defining a first feed of a first input, another CPW circuit design on the first side of the dielectric defining a second feed of a second input; (b) multiple radiator structures on the first side of the dielectric, including a monopole radiator and capacitive coupled radiator, other capacitive coupled radiators and matching stubs on the second side of a dielectric; and (c) a decoupling circuit, including its mutual decoupling micro strip line, between first and second antenna circuitries. The antenna may be dimensioned for being ceiling-mounted indoors, and may be operable at frequencies in the frequency range from 617 MHz to 8500 MHz.

In accordance with another aspect of the invention, there is provided an antenna for use in a distributed antenna system, the antenna comprising: (a) a feeding circuit disposed on a top side of a dielectric, the feeding circuit comprising a coplanar waveguide comprising a signal feed and a signal return coplanar with and interfittedly apart from the signal feed; (b) the radiator circuit comprising a monopole radiator, a capacitively coupling radiator on the top side of PCB and an another capacitively coupling radiator on the back side of PCB, and a return radiator is coplanar with the monopole radiator and spaced apart from the monopole radiator by slot.

In accordance with another aspect of the invention, there is provided a multiple-input and multiple-output (MIMO) antenna for use in a distributed antenna system. The MIMO antenna includes: (a) a feeding circuit disposed on a dielectric substrate, the feeding circuit including a coplanar waveguide (CPW) including a signal feed and a return, the return including first and second return sections coplanar with and apart from the signal feed; (b) first and second radiator circuits disposed on the dielectric substrate, the first and second radiator circuits including first and second monopole radiators, respectively, the first and second return sections being coplanar with and spaced apart from the first monopole radiator; (c) a decoupling circuit disposed on a first side of the dielectric substrate, the decoupling circuit including a conductive strip for reducing mutual coupling between the first and second radiator circuits; and (d) a matching circuit including a plurality of stubs disposed on a second side of the dielectric substrate opposite the first side, the matching circuit being operable to reduce return loss of the MIMO antenna.

The first and second return sections may be coplanar to each other. The first and second return sections may be disposed on either side of at least a portion of the signal feed. The first and second return sections may be separated from the at least a portion of the signal feed by a trace-free gap. The feeding circuit may further include a second CPW including a second signal feed and a second return. The second return may include first and second second-return sections coplanar with and apart from the second signal feed. The MIMO antenna may be a broadband antenna. The first and second radiator circuits may further include first and second capacitively coupled radiators, respectively. Each of the first and second capacitively coupled radiators may include an infra-Gigahertz (GHz) capacitively coupled radiator operable to transmit electromagnetic radiation in a plurality of frequency bands within the frequency range of 617 MHz to 960 MHz. The infra-GHz capacitively coupled radiator may be disposed on the first side of the dielectric substrate. Each of the first and second capacitively coupled radiators may include a supra-GHz capacitively coupled radiator operable to transmit electromagnetic radiation in a plurality of frequency bands within the frequency range of 1000 MHz to 4000 MHz. The supra-GHz capacitively coupled radiator may be disposed on the second side of the dielectric substrate. The MIMO antenna may further include a radome enclosing the dielectric substrate. The radome may have a diameter not greater than 230 millimeters (mm). The radome may have a height not greater than 10 mm. The feeding circuit may be operable to feed the first radiator circuit. The MIMO antenna may further include a second such feeding circuit operable to feed the second radiator circuit. The conductive strip may be disposed between the feeding circuit and the second feeding circuit. The first and second radiator circuits may further include first and second capacitively coupled radiators, respectively. Each of the first and second capacitively coupled radiators may be disposed on the first and second sides of the dielectric substrate. The feeding circuit may be disposed on the first and second sides of the dielectric substrate. The first and second radiator circuits may be disposed on the first and second sides of the dielectric substrate. The decoupling circuit may be disposed on the first side of the dielectric substrate. The matching circuit may be disposed on the second side of the dielectric substrate. The monopole radiator may be disposed on the first side of the dielectric substrate. The first and second radiator circuits may further include first and second capacitively coupled radiators, respectively. Each of the first and second capacitively coupled radiators may be disposed on the first and second sides of the dielectric substrate. The conductive strip of the decoupling circuit may include first, second, and third conductive sections coplanar with and spaced apart from the return. The second conductive section may be elongated and extend between the first and third conductive sections. The second conductive section may have a width substantially less than respective widths of the first and third conductive sections. An electrical current distribution at the conductive strip may have a phase that is substantially opposite to a return-phase of a return current distribution disposed at the return, such that there may be decoupling of the first and second radiator circuits from each other. The first and third conductive sections may be U-shaped. The MIMO antenna may further include a radome dimensioned for receiving a cable holder. The cable holder may be operable to receive a feed cable comprising a signal conductor and a ground conductor. The cable holder may be dimensioned to receive the feed cable such that the signal conductor is electrically connectable to the signal feed and such that the ground conductor is electrically connectable to the return. The MIMO antenna may be dimensioned for receiving a nut for mounting the MIMO antenna to a building structure such that the nut is electrically isolated from the feeding circuit and the first and second radiator circuits. The MIMO antenna may be operable to transmit electromagnetic radiation in a plurality of frequency bands within a frequency range from 617 MHz to 8500 MHz.

In accordance with another aspect of the invention, there is provided an antenna for use in a distributed antenna system. The antenna includes: (a) first means for wirelessly transmitting a signal; (b) second means for capacitively coupling the signal to the first means; (c) means for electrically connecting the signal to the second means; (d) means for decoupling circuitry of the antenna; and (e) means for matching impedance across a broad bandwidth.

The first means may be operable to wirelessly receive a receive signal.

The foregoing summary is illustrative only and is not intended to be in anyway limiting. Other aspects and features of the present invention will become apparent to those of ordinary skill in the art upon review of the following description of embodiments of the invention in conjunction with the accompanying figures and claims.

### BRIEF DESCRIPTION OF THE DRAWINGS

In drawings which illustrate by way of example only embodiments of the invention:

FIG. 1 is a perspective view of an antenna for use in a distributed antenna system (DAS), according to a first embodiment of the invention;

FIG. 2 is a top view of a main side of a printed circuit board (PCB) of the antenna shown in FIG. 1, showing monopole radiators, coplanar waveguide (CPW) feeding circuits, infra-Gigahertz (GHz) capacitively coupled radiators, decoupling circuit, and signal-radiator returns;

FIG. 3 is a top view of a feed side of the PCB of the antenna shown in FIG. 1, showing supra-GHz capacitively coupled radiators, CPW backside ground traces, and matching circuit stubs;

FIG. 4 is a close-up top view of a portion of the main side shown in FIG. 2, showing CPW feeding circuits and a decoupling circuit near a cable feeding area;

FIG. 5 is a side elevation view of the antenna shown in FIG. 1, showing the antenna mounted to a ceiling of a building structure; and

FIG. 6 is a graphical representation of voltage standing wave ratio (VSWR) vs. frequency measurement values for the antenna shown in FIG. 1, showing operational suitability of the antenna at multiple frequency bands from 617 MHz to 8500 MHz.

### DETAILED DESCRIPTION OF EMBODIMENTS

An antenna for use in a distributed antenna system (DAS) includes: (a) first means for wirelessly transmitting a signal; (b) second means for capacitively coupling the signal to the first means; and (c) means for electrically connecting the signal to the second means. The antenna may further include means for decoupling circuitry of the antenna. The antenna may further include means for matching impedance across a broad bandwidth. The antenna may include one or more of means for conditioning the signal, means for enclosing the second means, and means for mounting the first means. The first means may be operable to wirelessly receive a receive signal.

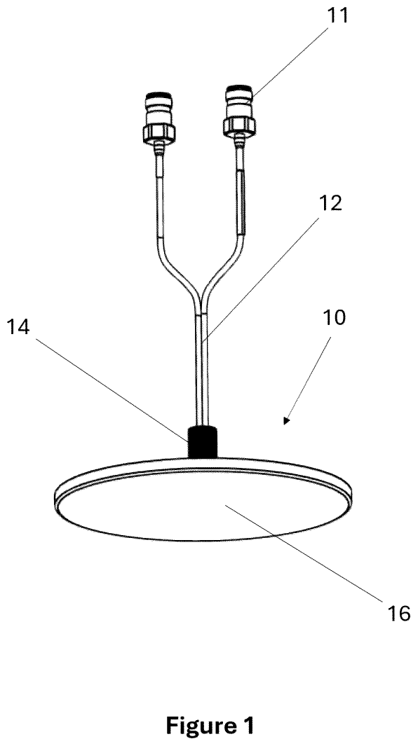

Referring to FIG. 1, the antenna according to a first embodiment of the invention is shown generally at 10. The antenna 10 is suitable for use in a DAS and is operable to transmit electromagnetic radiation in a plurality of frequency bands within the frequency range of 617 Megahertz (MHz) to 8500 MHz, such that the antenna 10 is a broadband antenna 10. In the first embodiment the frequency bands of interest are the cellular bands, including at the low frequency of 617 MHz, and the high frequency of 8500 MHz.

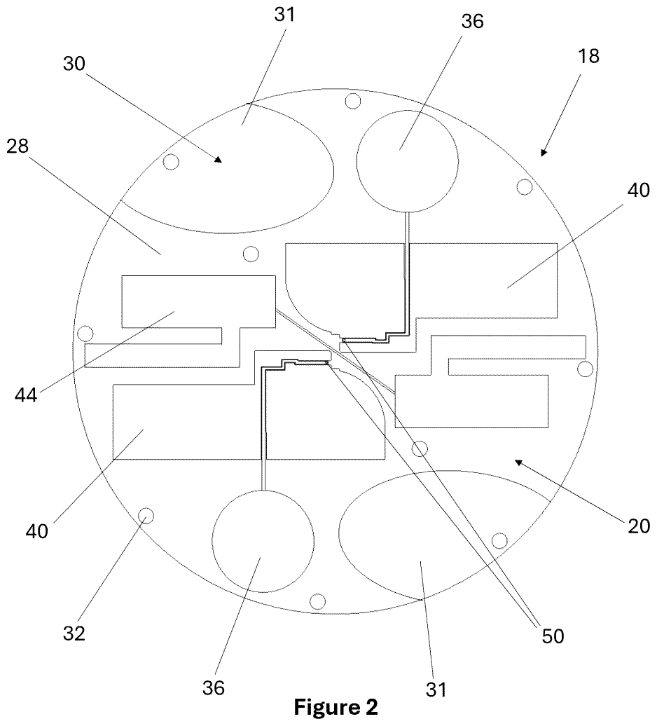

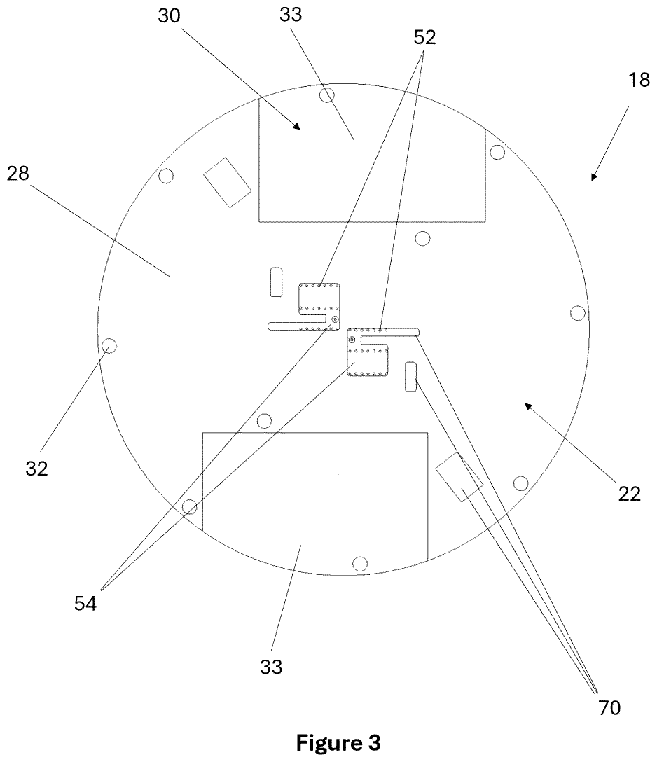

Referring to FIGS. 1-3, the antenna 10 of the first embodiment is operable to receive a pair of feed cables 12 into a cable housing 14 formed in or attached to a radome 16. A printed circuit board (PCB) 18 defines a main side 20 (FIG. 2) and a feed side 22 (FIG. 3) that are covered by the radome 16. While not directly visible in FIG. 1, in the first embodiment the main side 20 and the feed side 22 are parallel to each other and are disposed on the PCB 18 at opposite sides thereof.

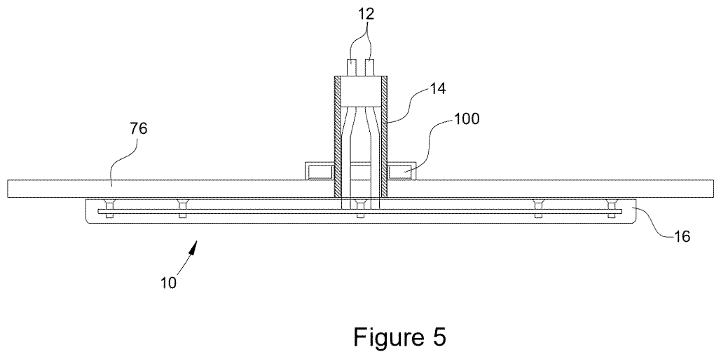

Referring particularly to FIG. 1, the radome 16 is typically made out of plastic or a similar material, and the radome 16 includes the cable housing 14. In variations, the radome 16 may define a back cover (not shown in FIGS. 1-3) or other attachment means such as mounting threads (see FIG. 5 described below), for example, for mounting the antenna 10 to a ceiling 76 (FIG. 5). The cable housing 14 is operable to receive and hold the feed cables 12. The cable housing 14 in the first embodiment is also useful for mounting the antenna 10 to a ceiling 76 (FIG. 5), as described further below.

Referring to FIGS. 2 and 3, the PCB 18 includes a dielectric material 28 that is electrically insulating, and the PCB 18 also includes an electrically conductive material 30 that in the first embodiment is made of copper and is printed on the PCB 18 according to known procedures for creating printed circuits on a printed circuit board. The PCB 18 includes mounting holes 32 extending through the PCB 18 in a direction perpendicular to the radome 16 plane (FIG. 1).

The antenna 10 is a multiple-input and multiple-output (MIMO) antenna that includes multiple radiator circuits, such as a pair of radiator circuits. Each feed cable 12 is connected at the PCB 18 to each radiator circuit, respectively, and the opposing ends of each feed cable 12 typically includes a connector 11 for connecting to other equipment (not shown). Each radiator circuit of the first embodiment includes a monopole radiator, such as the radiator element of each monopole 36 shown in FIG. 2, that is separated from an electrically grounded return, such as the signal-radiator return 40 shown in FIG. 2. The radiator elements of each monopole 36 and its corresponding signal-radiator return 40 are coplanar on the main side 20 of the PCB 18.

In the exemplary embodiment of FIG. 1, each feed cable 12 is a coaxial cable having exposed at its terminal end (i.e. opposite the connector 11) a signal conductor (not visible), and a ground conductor, such as a braided shield.

Referring to FIG. 2 showing a main side of the PCB 18, the antenna 10 includes in the first embodiment a decoupling circuit, such as the copper strip 44 located between the respective signal-radiator returns 40 of two radiator circuits of the MIMO antenna 10. In the first embodiment, the electrical current distributed on the copper strip 44 has substantially the opposite phase to that on the signal-radiator return 40, thereby improving isolation (i.e. reducing mutual coupling) between the radiator circuits of the antenna 10. As shown in FIG. 2, the copper strip 44 includes first, second, and third sections disposed on the main side 20 of the PCB 18 coplanar with and spaced apart from other circuitry on the main side 20 of the PCB 18 such as the signal-radiator return 40. In the first embodiment, the first and third sections are U-shaped and the second section is elongated and extends between the first and third sections so as to electrically connect the first and third sections to each other. As can be readily seen in FIG. 2, the second section of the copper strip 44 is notably narrower than the first and third sections of the copper strip 44. The isolation between the radiator circuits of the antenna 10 provided by the decoupling circuit advantageously improves isolation between the respective monopoles 36,

Referring to FIG. 2, an infra-Gigahertz (GHz) capacitively coupled radiator 31 is electrically disconnected from the monopole 36, but is capacitively coupled to the monopole 36. In the first embodiment, the infra-GHz capacitively coupled radiator 31 is operable to transmit electromagnetic radiation in a plurality of frequency bands within the frequency range of 617 MHz to 960 MHz. In the first embodiment, there are two radiator circuits, thus there are two monopoles 36 and two infra-GHz capacitively coupled radiators 31 disposed on the main side 20 of the PCB 18 that are capacitively coupled to the two monopoles 36, respectively. However, the two monopoles 36 are isolated from each other, and the two infra-GHz capacitively coupled radiators 31 are isolated from each other, in the first embodiment, due to the copper strip 44. In variations of embodiments, a different plural number of radiator circuits may be employed in each MIMO antenna 10.

Referring to FIG. 3 showing a feed side of the PCB 18, the supra-GHz capacitively coupled radiator 33 is electrically disconnected from the infra-GHz capacitively coupled radiator 31 and the monopole 36, but is capacitively coupled to the infra-GHz capacitively coupled radiator 31 and the monopole 36. In the first embodiment, the supra-GHz capacitively coupled radiator 33 is operable to transmit electromagnetic radiation in a plurality of frequency bands within the frequency range of 1000 MHz to 4000 MHz. In the first embodiment, there are two radiator circuits, thus there are two monopoles 36, two infra-GHz capacitively coupled radiators 31, and two supra-GHz capacitively coupled radiators 33. The supra-GHz capacitively coupled radiators 33 are disposed on the feed side 22 of the PCB 18. The two supra-GHz capacitively coupled radiators 33 are capacitively coupled to the two monopoles 36 and the two infra-GHz capacitively coupled radiators 31, respectively. However, the two supra-GHz capacitively coupled radiators 33 are isolated from each other, in the first embodiment, due to the copper strip 44.

Referring to FIGS. 2 and 3, which show opposite (main and feed) sides of the PCB 18, the inner conductor (not shown) of each cable 12 (FIG. 1) is electrically connected to a feed-signal point 50 (FIG. 2) by extending through the PCB 18 and dielectric material 28 from the feed side 18 to the main side 20 of the PCB 18. Each feed-signal point 50 is electrically connected to its corresponding monopole 36 of a corresponding radiator circuit. For each radiator circuit, the electrical connection from the feed-signal point 50 to the monopole 36, together with the corresponding signal-radiator return 40, forms a coplanar waveguide (CPW). For each radiator circuit, the braided shield of each cable 12 is electrically connected to the signal-radiator return 40 via a CPW backside ground trace 54 (FIG. 3), which is disposed on the feed side 22 of the PCB 18. In the first embodiment, the feed-signal points 50 are disposed inside the radome 16 of the antenna 10 for feeding the signal received from the feed cable 12 to the radiator circuits at the PCB 18.

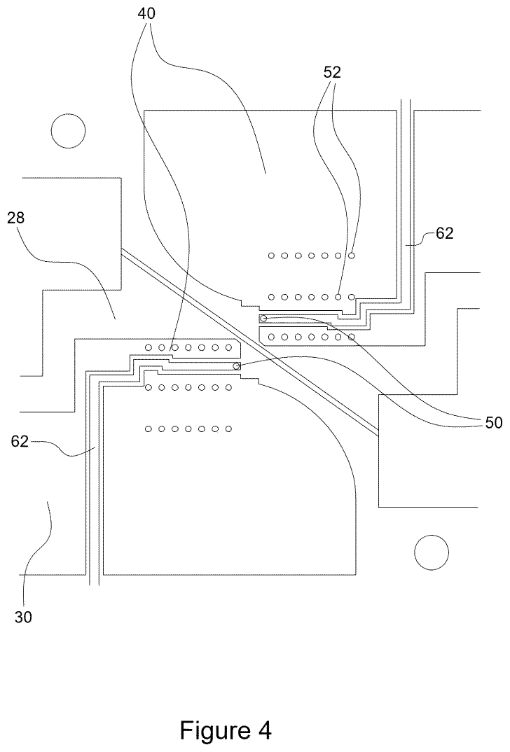

Referring to FIGS. 3 and 4, the feed-signal points 50 and the CPW backside ground traces 54 are parallel to each other on opposing sides of the PCB 18 and are separated from each other by the dielectric material 28 so as to define a feed-signal circuit. A portion of the main side 20 of the PCB 18 is shown in FIG. 4.

A feeding circuit is defined by electrically conductive material 30 that in the first embodiment is made of copper printed on the PCB 18 so as to include a coplanar waveguide implementing the signal-feed circuit including the signal-feed trace 62, shown in FIG. 4, that is separated from a signal return, such as the plurality of signal-radiator return 40 sections shown in FIG. 4. The dielectric material 28 that is non-conductive is visible in FIG. 4 between each signal-feed trace 62 and its corresponding pair of signal-radiator return 40 sections disposed on either side of the signal-feed trace 62. In the first embodiment, the plurality of signal-radiator returns 40 effectively surround and are coplanar with the signal-feed traces 62 while being separated from the signal-feed traces 62 by trace-free gaps defined by the exposure of the dielectric material 28, respectively. Each signal-feed trace 62 and its corresponding signal-radiator return 40 are coplanar to and spaced apart from each other on the main side 20 of the PCB 18. The signal-feed traces 62 and the signal-radiator return 40 sections are also coplanar with each of the monopoles 36. In the first embodiment, there are two radiator circuits, thus there are two feeding circuits. The two feeding circuits include two signal-feed traces 62 and two signal-radiator returns 40 disposed on the main side 20 of the PCB 18. The two signal-feed traces 62 are isolated from each other, and the two signal-radiator returns 40 are isolated from each other, in the first embodiment, due to the copper strip 44. However, the two signal-radiator return 40 sections of each signal-radiator return 40 are not isolated from each other in the first embodiment.

The conductive material 30 is also employed to define an impedance-matching circuit 70 (FIG. 3) in shunt capacitive mode that is particularly effective for the wide band. The impedance-matching circuit 70 includes rectangular traces forming stubs on the feed side 22 of the PCB 18.

Still referring to FIG. 3, the inner conductor of the cable 12 is electrically connected to the signal-feed trace 62 disposed on the main side 20 of PCB 18, and the braided shield of the cable 12 is electrically connected to the CPW backside ground trace 54, further connected to signal-radiator return 40 of PCB 18 by vias 52 that extend through the dielectric material 28 from one side to the other side of the PCB 18. In the first embodiment, there are two radiator circuits, thus there are two feeding circuits that include two CPW backside ground traces 54 disposed on the feed side 22 of the PCB 18. The two CPW backside ground traces 54 are not isolated from each other in the first embodiment.

Referring to FIG. 5, the antenna 10 is suitable for being mounted indoors at a ceiling 76 of a building structure. In the exemplary mounting configuration of FIG. 5, the antenna 10, including its radome 16, is entirely beneath the ceiling 76 and is mounted to the ceiling 76 by the nut 100 that is threadedly connected to the cable housing 14 having threads for that purpose.

Still referring to FIG. 5, the antenna 10 of the first embodiment is a low-profile, 230 mm maximum-diameter planar antenna 10 having a maximum vertical height of 10 mm.

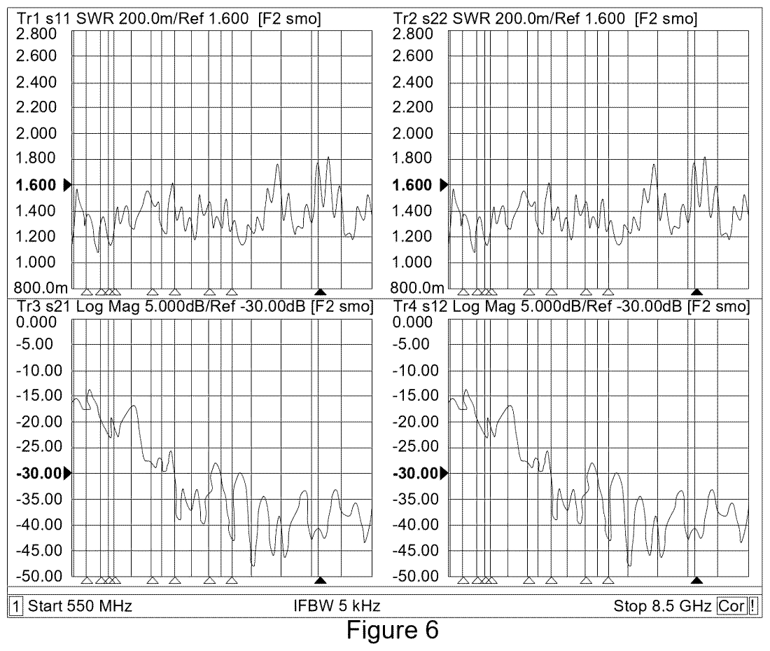

Referring to FIG. 6, the antenna 10 is particularly suitable for transmitting electromagnetic radiation in multiple frequency bands, including specifiable cellular bands in the frequency range of 617 MHz to 8500 MHz. The voltage standing wave ratio (VSWR) of the antenna 10, measured in a free-space environment, is less than 1.5:1 at frequencies within these specifiable cellular bands. The isolation between the different radiator circuits of the antenna 10 is at least 15 dB.

In the first embodiment, the radiator PCB 18, the feed cable 12, and connector 11 have low passive intermodulation (PIM) distortion performance ratings. Accordingly, the antenna 10 according to the first embodiment is a low-PIM antenna 10.

Thus, there is provided a MIMO antenna for use in a distributed antenna system, the MIMO antenna comprising: (a) a feeding circuit disposed on a dielectric substrate, the feeding circuit comprising a coplanar waveguide (CPW) comprising a signal feed and a return, the return comprising first and second return sections coplanar with and apart from the signal feed; (b) first and second radiator circuits disposed on the dielectric substrate, the first and second radiator circuits comprising first and second monopole radiators, respectively, the first and second return sections being coplanar with and spaced apart from the first monopole radiator; (c) a decoupling circuit disposed on a first side of the dielectric substrate, the decoupling circuit comprising a conductive strip for reducing mutual coupling between the first and second radiator circuits; and (d) a matching circuit comprising a plurality of stubs disposed on a second side of the dielectric substrate opposite the first side, the matching circuit being operable to reduce return loss of the MIMO antenna.

While embodiments of the invention have been described and illustrated, such embodiments should be considered illustrative of the invention only. Thus, the embodiments described and illustrated herein should not be considered to limit the invention as construed in accordance with the accompanying claims.

What is claimed is:

1. A multiple-input and multiple-output (MIMO) antenna for use in a distributed antenna system, the MIMO antenna comprising:
(a) a feeding circuit disposed on a dielectric substrate, the feeding circuit comprising a coplanar waveguide (CPW) comprising a signal feed and a return, the return comprising first and second return sections coplanar with and apart from the signal feed;
(b) first and second radiator circuits disposed on the dielectric substrate, the first and second radiator circuits comprising first and second monopole radiators, respectively, the first and second return sections being coplanar with and spaced apart from the first monopole radiator;
(c) a decoupling circuit disposed on a first side of the dielectric substrate, the decoupling circuit comprising a conductive strip for reducing mutual coupling between the first and second radiator circuits; and
(d) a matching circuit comprising a plurality of stubs disposed on a second side of the dielectric substrate opposite the first side, the matching circuit being operable to reduce return loss of the MIMO antenna.

2. The MIMO antenna of claim 1 wherein the first and second return sections are coplanar to each other, disposed on either side of at least a portion of the signal feed, and are separated from the at least a portion of the signal feed by a trace-free gap.

3. The MIMO antenna of claim 1 wherein the feeding circuit further comprises a second CPW comprising a second signal feed and a second return, the second return comprising first and second second-return sections coplanar with and apart from the second signal feed.

4. The MIMO antenna of claim 1 wherein the MIMO antenna is a broadband antenna, the first and second radiator circuits further comprising first and second capacitively coupled radiators, respectively.

5. The MIMO antenna of claim 4 wherein each of the first and second capacitively coupled radiators comprises an infra-Gigahertz (GHz) capacitively coupled radiator operable to transmit electromagnetic radiation in a plurality of frequency bands within the frequency range of 617 MHz to 960 MHz.

6. The MIMO antenna of claim 4 wherein each of the first and second capacitively coupled radiators comprises a supra-GHz capacitively coupled radiator operable to transmit electromagnetic radiation in a plurality of frequency bands within the frequency range of 1000 MHz to 4000 MHz.

7. The MIMO antenna of claim 5 wherein each of the first and second capacitively coupled radiators comprises a supra-GHz capacitively coupled radiator operable to transmit electromagnetic radiation in a plurality of frequency bands within the frequency range of 1000 MHz to 4000 MHz.

8. The MIMO antenna of claim 1 further comprising a radome enclosing the dielectric substrate, the radome having a diameter not greater than 230 millimeters (mm) and a height not greater than 10 mm.

9. The MIMO antenna of claim 1 wherein the feeding circuit is operable to feed the first radiator circuit, the MIMO antenna further comprising a second said feeding circuit operable to feed the second radiator circuit, the conductive strip being disposed between the feeding circuit and said second feeding circuit.

10. The MIMO antenna of claim 1 wherein the first and second radiator circuits further comprise first and second capacitively coupled radiators, respectively, each of the first and second capacitively coupled radiators being disposed on the first and second sides of the dielectric substrate.

11. The MIMO antenna of claim 1 wherein the feeding circuit is disposed on the first and second sides of the dielectric substrate, the first and second radiator circuits are disposed on the first and second sides of the dielectric substrate, the decoupling circuit is disposed on the first side of the dielectric substrate, and the matching circuit is disposed on the second side of the dielectric substrate.

12. The MIMO antenna of claim 10 wherein the monopole radiator is disposed on the first side of the dielectric substrate, the first and second radiator circuits further comprising first and second capacitively coupled radiators, respectively, each of the first and second capacitively coupled radiators being disposed on the first and second sides of the dielectric substrate.

13. The MIMO antenna of claim 1 wherein the conductive strip of the decoupling circuit comprises first, second, and third conductive sections coplanar with and spaced apart from the return, the second conductive section being elongated and extending between the first and third conductive sections, the second conductive section having a width substantially less than respective widths of the first and third conductive sections.

14. The MIMO antenna of claim 13 wherein an electrical current distribution at the conductive strip has a phase that is substantially opposite to a return-phase of a return current distribution disposed at the return, thereby decoupling the first and second radiator circuits from each other.

15. The MIMO antenna of claim 14 wherein the first and third conductive sections are U-shaped.

16. The MIMO antenna of claim 1 further comprising a radome dimensioned for receiving a cable holder operable to receive a feed cable comprising a signal conductor and a ground conductor, the cable holder being dimensioned to receive the feed cable such that the signal conductor is electrically connectable to the signal feed and such that the ground conductor is electrically connectable to the return.

17. The MIMO antenna of claim 1 wherein the MIMO antenna is dimensioned for receiving a nut for mounting the MIMO antenna to a building structure such that the nut is electrically isolated from the feeding circuit and the first and second radiator circuits.

18. The MIMO antenna of claim 1 wherein the MIMO antenna is operable to transmit electromagnetic radiation in a plurality of frequency bands within a frequency range from 617 Megahertz (MHz) to 8500 MHz.

19. An antenna for use in a distributed antenna system, the antenna comprising:
(a) first means for wirelessly transmitting a signal;
(b) second means for capacitively coupling the signal to the first means;
(c) means for electrically connecting the signal to the second means;
(d) means for decoupling circuitry of the antenna; and
(e) means for matching impedance across a broad bandwidth.

20. The antenna of claim 19 wherein the first means is operable to wirelessly receive a receive signal.
